(19) United States
(12) Patent Application Publication
(10) Pub. No.: US 2011/0115812 A1
(43) Pub. Date: May 19, 2011

(54) METHOD FOR COLORIZATION OF POINT CLOUD DATA BASED ON RADIOMETRIC IMAGERY

(75) Inventors: Kathleen Minear, Palm Bay, FL (US); Anthony O'Neil Smith, Melbourne, FL (US)

(73) Assignee: Harris Corporation, Melbourne, FL (US)

(21) Appl. No.: 12/617,751

(22) Filed: Nov. 13, 2009

(51) Int. Cl. G09G 5/02

(52) U.S. Cl. 345/593

(57) ABSTRACT

Systems and methods for improving visualization and interpretation of spatial data of a location are provided. In the method, a first radiometric image and three-dimensional (3-D) point cloud data registered (306) and the radiometric image is divided into a first plurality of image regions (308). Afterwards, one or more cloud data portions of the 3-D point cloud data associated with each of the first plurality of image regions are identified based on the registering (312). Portion color values, consisting of the region color values for corresponding ones of the first plurality of regions, are then applied to the cloud data portions (314). In some cases, an adjustment of the color values can be performed (318).

### BACKGROUND OF THE INVENTION

1. Statement of the Technical Field

The present invention is directed to the field of colorization of point cloud data, and more particularly for colorization of point cloud data based on radiometric imagery.

2. Description of the Related Art

Three-dimensional (3-D) type sensing systems are commonly used to generate 3-D images of a location for use in various applications. For example, such 3-D images are used for creating a safe training or planning environment for military operations or civilian activities, for generating topographical maps, or for surveillance of a location. Such sensing systems typically operate by capturing elevation data associated with the location. One example of a 3-D type sensing system is a Light Detection And Ranging (LIDAR) system. LIDAR type 3-D sensing systems generate data by recording multiple range echoes from a single pulse of laser light to generate a frame sometimes called image frame. Accordingly, each image frame of LIDAR data will be comprised of a collection of points in three dimensions (3-D point cloud) which correspond to the multiple range echoes within sensor aperture. These points can be organized into “voxels” which represent values on a regular grid in a three dimensional space. Voxels used in 3-D imaging are analogous to pixels used in the context of 2D imaging devices. These frames can be processed to reconstruct a 3-D image of the location. In this regard, it should be understood that each point in the 3-D point cloud has an individual x, y and z value, representing the actual surface within the scene in 3-D.

To further assist interpretation of the 3-D point cloud, color maps have been used to enhance visualization of the point cloud data. That is, for each point in a 3-D point cloud, a color is selected in accordance with a predefined variable, such as altitude. Accordingly, the variations in color are generally used to identify points at different heights or at altitudes above ground level. Notwithstanding the use of such conventional color maps, 3-D point cloud data has remained difficult to interpret.

### SUMMARY OF THE INVENTION

Embodiments of the invention concern systems and methods for colorization of 3-D point cloud data based on radiometric imagery. In a first embodiment of the invention, a method for improving visualization and interpretation of spatial data of a location is provided. The method includes registering at least a first radiometric image and three-dimensional (3-D) point cloud data. The method also includes dividing the first radiometric image into a first plurality of image regions and identifying one or more cloud data portions of the 3-D point cloud data associated with each of the first plurality of image regions based on the registering. The method further includes applying portion color values to the cloud data portions, the portion color values including region color values for corresponding ones of the first plurality of regions.

In a second embodiment of the invention, a system for improving visualization and interpretation of spatial data of a location is provided. The system includes a storage element for storing at least a first radiometric image and three-dimensional (3-D) point cloud data associated with the first radiometric image. The system also includes a processing element communicatively coupled to the storage element. In the system, the processing element is configured for registering at least a first radiometric image and three-dimensional (3-D) point cloud data. The processing element is also configured for dividing the first radiometric image into a first plurality of image regions and identifying one or more cloud data portions of the 3-D point cloud data associated with each of the first plurality of image regions based on the registering. The processing element is further configured for applying portion color values to the cloud data portions, the portion color values including region color values for corresponding ones of the first plurality of regions.

In a third embodiment of the invention, a computer-readable medium is provided having stored thereon a computer program for improving visualization and interpretation of spatial data of a location. The computer program includes a plurality of code sections executable by a computer for causing the computer to register at least a first radiometric image and three-dimensional (3-D) point cloud data. The computer program also includes code sections for dividing the first radiometric image into a first plurality of image regions and identifying one or more cloud data portions of the 3-D point cloud data associated with each of the first plurality of image regions based on the registering. The computer program further includes code sections for applying portion color values to the cloud data portions, the portion color values including region color values for corresponding ones of the first plurality of regions.

### BRIEF DESCRIPTION OF THE DRAWINGS

FIG. 1 shows an exemplary data collection system for collecting 3-D point cloud data in accordance with an embodiment of the present invention.

FIG. 2 shows an exemplary image frame containing 3-D point cloud data acquired in accordance with an embodiment of the present invention.

FIG. 3 shows an exemplary method for point cloud colorization in accordance with an embodiment of the invention.

FIG. 4 shows an exemplary radiometric image.

FIG. 5 shows exemplary 3-D point cloud data corresponding to the radiometric image in FIG. 4.

FIG. 6 shows a portion of the radiometric image in FIG. 4 divided into regions in accordance with an embodiment of the invention.

FIG. 7A is an x-y plane view of the 3-D point cloud data in FIG. 5 after colorization in accordance with an embodiment of the invention.

FIG. 7B is a perspective view of the 3-D point cloud data in FIG. 5 after colorization in accordance with an embodiment of the invention.

FIG. 8 is an x-y plot illustrating exemplary curves for adjusting intensity and/or saturation of color values in accordance with an embodiment of the invention.

FIG. 9 shows another exemplary method for point cloud colorization in accordance with another embodiment of the invention.

FIG. 10 shows a schematic diagram of a computer system for executing a set of instructions that, when executed, can cause the computer system to perform one or more methodologies and procedures in accordance with an embodiment of the invention.

### DETAILED DESCRIPTION

The present invention is described with reference to the attached figures, wherein like reference numerals are used throughout the figures to designate similar or equivalent elements. The figures are not drawn to scale and they are provided merely to illustrate some embodiments of the present invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

A 3-D imaging system generates one or more frames of 3-D point cloud data. One example of such a 3-D imaging system is a conventional LIDAR imaging system, as described above. In general, such LIDAR systems use a high-energy laser, optical detector, and timing circuitry to determine the distance to a target. In a conventional LIDAR system, one or more laser pulses are used to illuminate a scene. Each pulse triggers a timing circuit that operates in conjunction with the detector array. In general, the system measures the time for each pixel of a pulse of light to transit a round-trip path from the laser to the target and back to the detector array. The reflected light from a target is detected in the detector array and its round-trip travel time is measured to determine the distance to a point on the target. The calculated range or distance information is obtained for a multitude of points comprising the target, thereby creating a 3-D point cloud. The 3-D point cloud can be used to render the 3-D shape of an object.

In general, interpreting 3-D point cloud data to identify objects in a scene can be difficult. Since the 3-D point cloud specifies only spatial information with respect to a reference location, at best only height and shape of objects in a scene is provided. Some conventional systems provide artificial coloring or shading of the 3-D point cloud data based on assumptions regarding the terrain or the types of objects in the scene to assist the observer's interpretation of the 3-D point cloud. However, such coloring or shading is typically insufficient to relate all of the object information in a 3-D point cloud to the observer. In general, the human visual cortex interprets objects being observed based on a combination of information about the surrounding scene, including the shape, the size, and the color or shading of different objects in the scene. Accordingly, a conventional 3-D point cloud, even if artificially colored, generally provides insufficient information for the visual cortex to properly identify many objects imaged by the 3-D point cloud. Since the human visual cortex operates by identifying observed objects in a scene based on previously observed objects, previously observed scenes, and known associations between different objects in different scenes, any improper coloring or shading of object can result in an incorrect identification of objects in a scene.

To overcome the limitations of conventional 3-D point cloud display systems and to facilitate the interpretation of 3-D point cloud data by the human visual cortex, embodiments of the present invention provide systems and methods for colorizing 3-D point cloud data based on a radiometric image. The term “radiometric image”, as used herein, refers to a two-dimensional representation (an image) of a location obtained by using one or more sensors or detectors operating on one or more electromagnetic wavelengths. In particular, the color values from the radiometric image are applied to the 3-D point cloud data based on a registration or alignment operation.

The term “color value”, as used herein, refers to the set of one or more values (i.e., tuples of numbers) used to define a point from a color map, such as a point in a red-green-blue (RGB) color map or a point in a intensity (grayscale) color map. However, the various embodiments of the invention are not limited in this regard. Rather, any type of color values associated with any type of color map can be used with the various embodiments of the invention. For example, in some embodiments of the invention the color values can define a point in a non-linear color map defined in accordance with hue, saturation and intensity (HSI color space). As used herein, “hue” refers to pure color, “saturation” refers to the degree or color contrast, and “intensity” refers to color brightness. Thus, a particular color in HSI color space is uniquely represented by a set of HSI values (h, s, i) called triples. The value of h can normally range from zero to 360° (0°≦h≦360°). The values of s and i normally range from zero to one (0≦s,≦1), (0≦i≦1). For convenience, the value of h as discussed herein shall sometimes be represented as a normalized value which is computed as h/360.

Significantly, HSI color space is modeled on the way that humans generally perceive color and can therefore be helpful when creating different color maps for visualizing 3-D point cloud data for different scenes. Furthermore, HSI triples can easily be transformed to other colors space definitions such as the well known RGB color space system in which the combination of red, green, and blue “primaries” are used to represent all other colors. Accordingly, colors represented in HSI color space can easily be converted to RGB values for use in an RGB based device. Conversely, colors that are represented in RGB color space can be mathematically transformed to HSI color space. An example of this relationship is set forth in the table below:

| RGB | his | Result |
|---|---|---|
| (1, 0, 0) | (0°, 1, 0.5) | Red |
| (0.5, 1, 0.5) | (120°, 1, 0.75) | Green |
| (0, 0, 0.5) | (240°, 1, 0.25) | Blue |

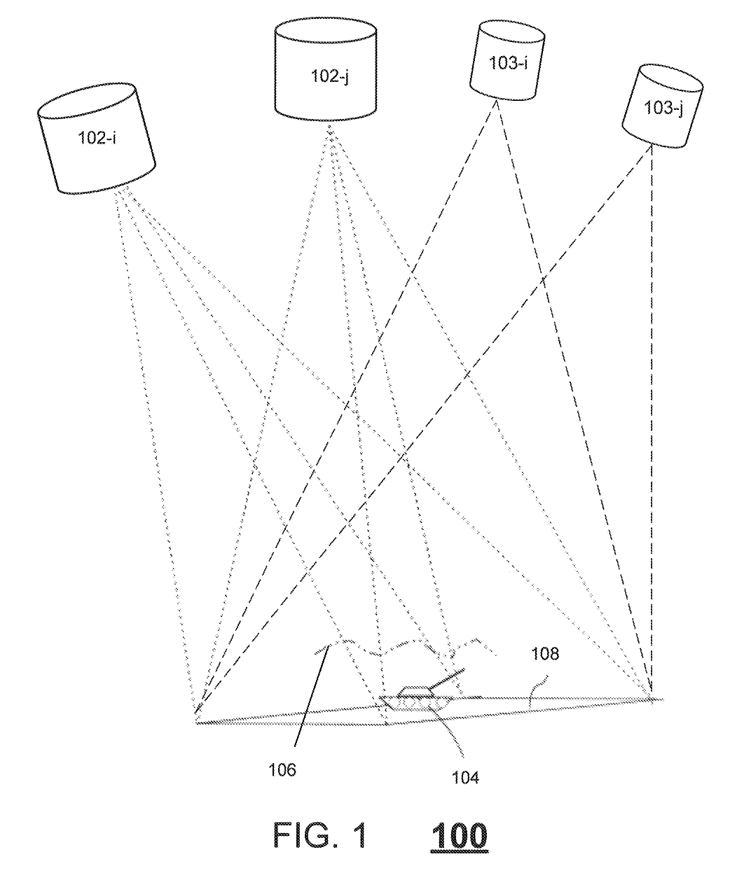

An exemplary data collection system 100 for collecting 3-D point cloud data and associated radiometric image data according to an embodiment of the present invention is shown in FIG. 1. As shown in FIG. 1, a geographic location or area 108 to be imaged can contain one or more objects 104, 106, such as trees, vehicles, and buildings. In the various embodiments of the inventions, the area 108 is imaged using a variety of different sensors. As shown in FIG. 1, 3-D point cloud data can be collected using one or more sensors 102-i, 102-j and the data for an associated radiometric image can be collected using one or more radiometric image sensors 103-i, 103-j. The sensors 102-i, 102-j, 103-i, and 103-j can be any remotely positioned sensor or imaging device. For example, the sensors 102-i, 102-j, 103-i, and 103-j can be positioned to operate on, by way of example and not limitation, an elevated viewing structure, an aircraft, a spacecraft, or a celestial object. That is, the remote data is acquired from any position, fixed or mobile, in view of the area 108 being imaged. Furthermore, although sensors 102-i, 102-j, 103-i, and 103-j are shown as separate imaging systems, two or more of sensors 102-i, 102-j, 103-i, and 103-j can be combined into a single imaging system. Additionally, a single sensor can be configured to obtain the data at two or more different poses. For example, a single sensor on an aircraft or spacecraft can be configured to obtain image data as it moves over the area 108.

In some instances, the line of sight between sensors 102-i and 102-j and an object 104 may be partly obscured by another object (occluding object) 106. In the case of a LIDAR system, the occluding object 106 can comprise natural materials, such as foliage from trees, or man made materials, such as camouflage netting. It should be appreciated that in many instances, the occluding object 106 will be somewhat porous in nature. Consequently, the sensors 102-i, 102-j will be able to detect fragments of object 104 which are visible through the porous areas of the occluding object 106. The fragments of the object 104 that are visible through such porous areas will vary depending on the particular location of the sensor.

By collecting data from several poses, such as at sensors 102-i and 102-j, an aggregation of 3-D point cloud data can be obtained. Typically, aggregation of the data occurs by means of a registration process. The registration process combines the data from two or more frames by correcting for variations between frames with regard to sensor rotation and position so that the data can be combined in a meaningful way. As will be appreciated by those skilled in the art, there are several different techniques that can be used to register this data. Subsequent to such registration, the aggregated 3-D point cloud data from two or more frames can be analyzed to improve identification of an object 104 obscured by an occluding object 106. However, the embodiments of the present invention are not limited solely to aggregated data. That is, the 3-D point cloud data can be generated using multiple image frames or a single image frame.

In the various embodiments of the present invention, the radiometric image data collected by sensors 103-i and 103-j can include intensity data for an image acquired from various radiometric sensors, each associated with a particular range of wavelengths (i.e., a spectral band). Therefore, in the various embodiments of the present invention, the radiometric image data can include multi-spectral (˜4 bands), hyper-spectral (>100 bands), and/or panchromatic (single band) image data. Additionally, these bands can include wavelengths that are visible or invisible to the human eye.

In the various embodiments of the present invention, aggregation of 3-D point cloud data or fusion of multi-band radiometric images can be performed using any type of aggregation or fusion techniques. The aggregation or fusion can be based on registration or alignment of the data to be combined based on meta-data associated with the 3-D point cloud data and the radiometric image data. The meta-data can include information suitable for facilitating the registration process, including any additional information regarding the sensor or the location being imaged. By way of example and not limitation, the meta-data includes information identifying a date and/or a time of image acquisition, information identifying the geographic location being imaged, or information specifying a location of the sensor. For example, information indentifying the geographic location being image can include geographic coordinates for the four corners of a rectangular image can be provided in the meta-data.

Although, the various embodiments of the present invention will generally be described in terms of one set of 3-D point cloud data for a location being combined with a corresponding set of one radiometric image data set associated with the same location, the present invention is not limited in this regard. In the various embodiments of the present invention, any number of sets of 3-D point cloud data and any number of radiometric image data sets can be combined. For example, mosaics of 3-D point cloud data and/or radiometric image data can be used in the various embodiments of the present invention.

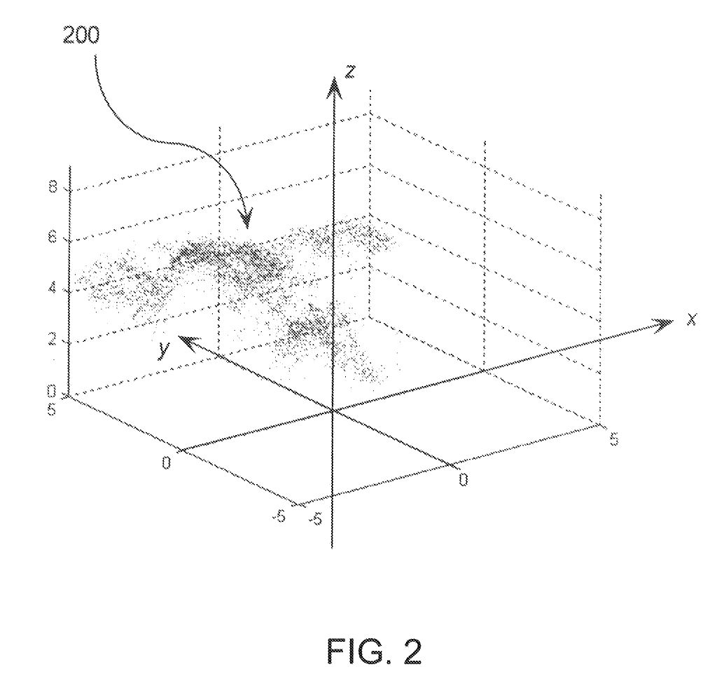

FIG. 2 is exemplary image frame containing 3-D point cloud data 200 acquired in accordance with an embodiment of the present invention. In some embodiments of the present invention, the 3-D point cloud data 200 can be aggregated from two or more frames of such 3-D point cloud data obtained by sensors 102-i, 102-j at different poses, as shown in FIG. 1, and registered using a suitable registration process. As such, the 3-D point cloud data 200 defines the location of a set of data points in a volume, each of which can be defined in a three-dimensional space by a location on an x, y, and z axis. The measurements performed by the sensors 102-i, 102-j and any subsequent registration processes (if aggregation is used) are used to define the x, y, z location of each data point. That is, each data point is associated with a geographic location and an elevation.

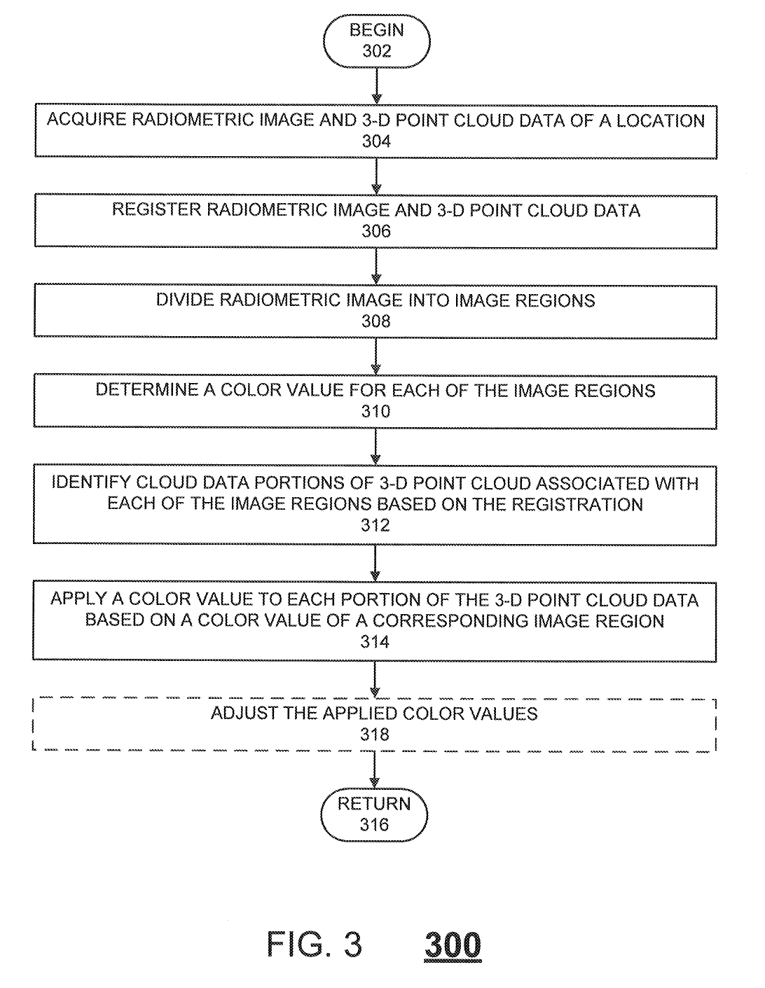

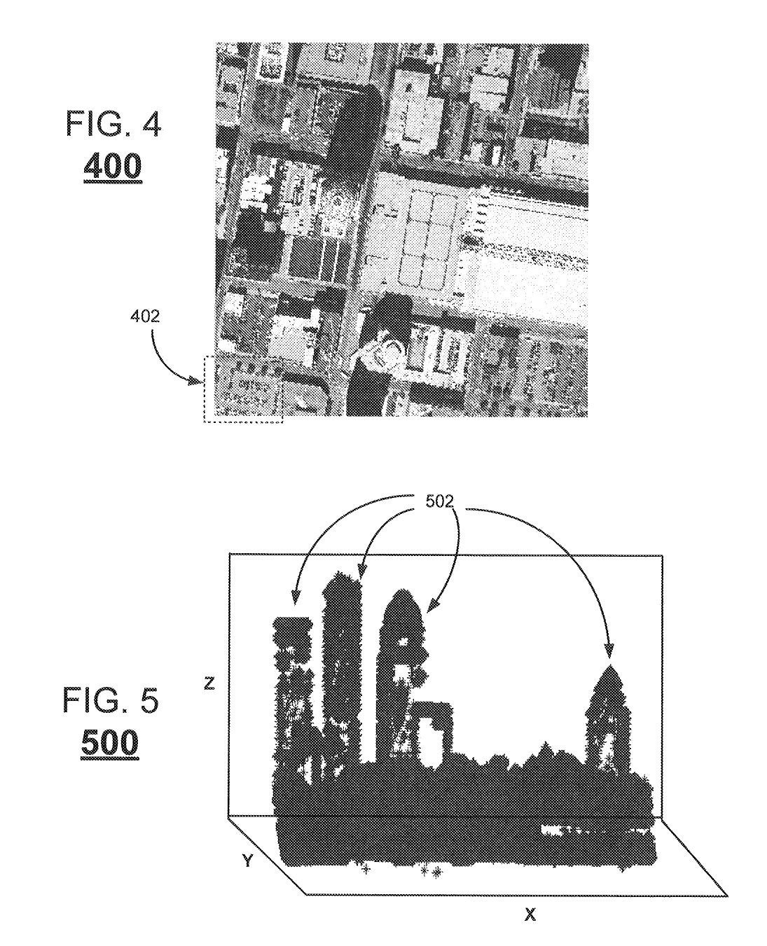

FIG. 3 shows an exemplary method 300 for point cloud colorization in accordance with an embodiment of the invention. The method 300 begins at block 302 and continues to block 304. At block 304, a radiometric image and 3-D point cloud data of a location are acquired. These can be acquired in a variety of ways, including the methods described above with respect to FIG. 1. An exemplary radiometric image of a location and a corresponding 3-D point cloud data set are shown in FIGS. 4 and 5. FIG. 4 shows an exemplary radiometric image and FIG. 5 shows exemplary 3-D point cloud data corresponding to the radiometric image in FIG. 4.

Referring back to FIG. 3, after the radiometric image and the 3-D point cloud data are acquired at block 304, the radiometric image and the 3-D point can be registered or aligned at block 306. The registration or alignment can be based on metadata, as described above. However, the various embodiments of the invention are not limited in this regard and any type of registration or alignment technique can be used.

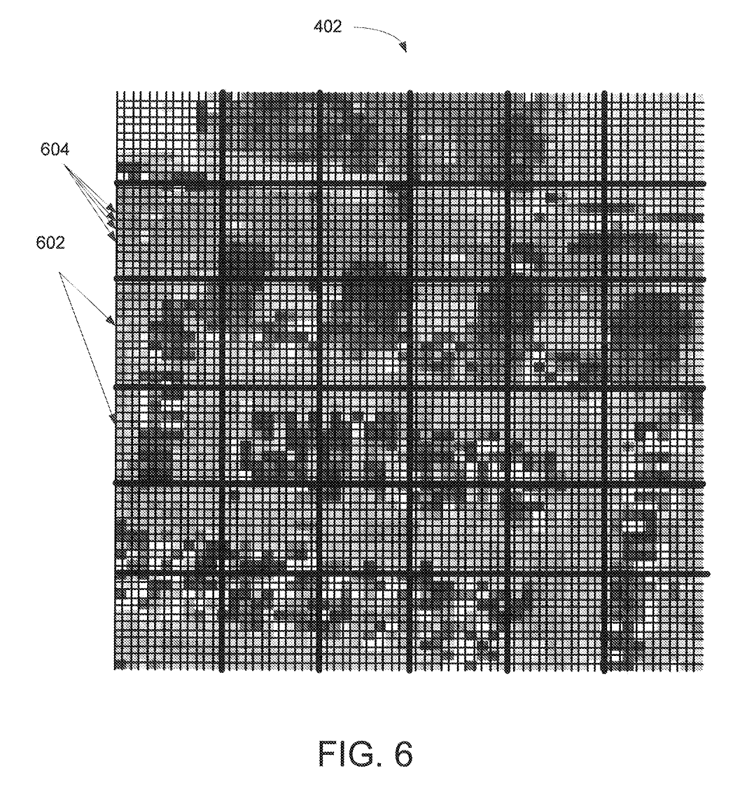

Once a registration for the radiometric image and the 3-D point cloud data is obtained at block 306, colorization of the 3-D point cloud can commence starting at block 308. At block 308, the radiometric image is first divided into image regions. In the various embodiments of the invention, the image regions can be of any shape or size and can include one or more pixels of the radiometric image. For example, FIG. 6 shows a close-up view of a section 402 of the radiometric image 400 in FIG. 4 divided into a grid of image regions. In some embodiments, these image regions can include a large number of pixels, such as image regions 602. In other embodiments, these image regions can include one or a few pixels, such as image regions 604. However the various embodiments of the invention are not limited to a grid pattern of image regions. For example, in some embodiments, shape identification and/or recognition algorithms can be applied to the radiometric image to select the size and shape of the image regions.

Once the image regions are defined at block 308, a color value for each of the image regions defined at block 306 can be determined at block 310. In the various embodiments of the invention, the color value for an image region can be determined in several ways. For example, in embodiments of the invention where each image region includes a plurality of pixels, the color value for an image region can be an average color value of pixels in an image region or a color value associated with a pixel in a central portion of the region. However, the various embodiments of the invention are not limited in this regard and other techniques for determining a color value for an image region can be used.

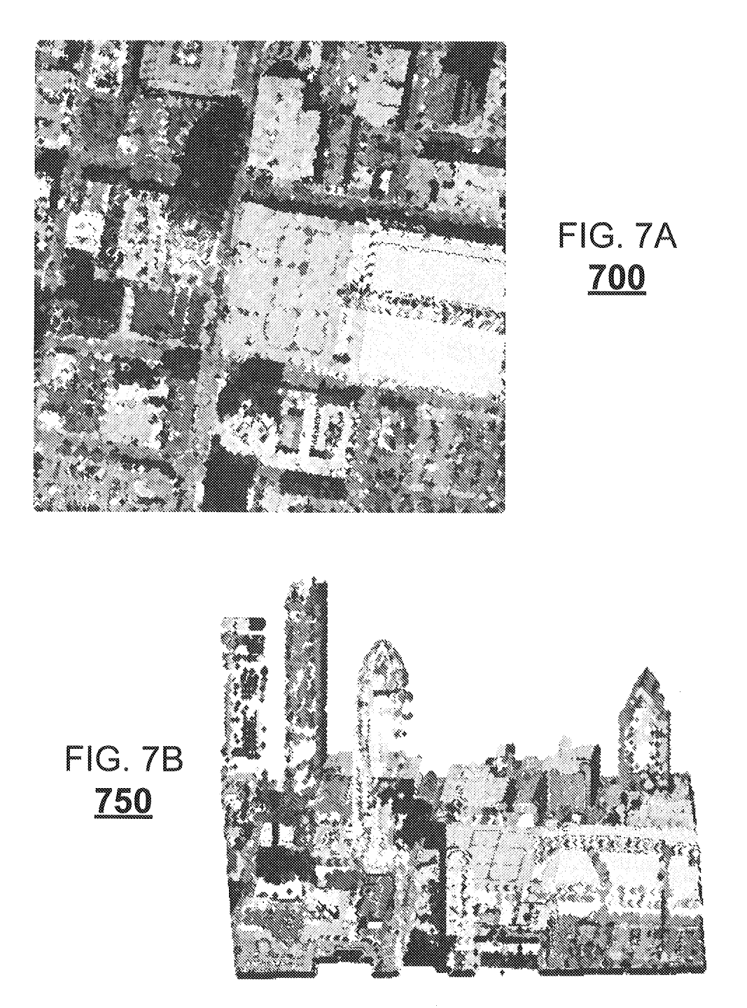

Subsequently or concurrently with block 310, the portions of the 3-D point cloud associated with each of the image regions are identified at block 312. These portions can be identified based on the registration at block 306. Afterwards, at block 314, the color values determined at block 310 for each image region are applied to the corresponding portions of the 3-D point cloud data identified at block 312 to produce a colorized 3-D point cloud. An exemplary result of this process is shown in FIGS. 7A and 7B. FIGS. 7A and 7B are an x-y plane view 700 and a perspective view 750, respectively, of the 3-D point cloud data of FIG. 5 after colorization based on the radiometric image in FIG. 4 in accordance with an embodiment of the invention. As can be observed in FIG. 7A, the resulting view 700 is substantially similar to the image 400 in FIG. 4 since the greatest amount of color information in image 400 is associated with this orientation of the 3-D point cloud data. The perspective view 750 in FIG. 7B appears to have “gaps”. However, this is due to the number of 3-D data points available. Therefore, for a 3-D point cloud with a higher density of points, such “gaps” would be reduced or eliminated. This can be accomplished by aligning multiple frames of point cloud data of the same location. Alternatively, coloring for such “gaps” could be selected based on interpolation to determine the color values for portions of the 3-D point cloud between data points. After the colorization at block 314, the method 300 can resume previous processing at block 316, such as storing updated 3-D point cloud data including the color values, presenting the colorized 3-D point cloud data to a user, or repeating method 300.

As described above, the image region size and shape can vary in the various embodiments of the invention, as described above with respect to FIG. 6. However, the image region size and shape can significantly affect accuracy and computational efficiency. For example, if the image regions 602 are selected at block 308, the color values determined at block 310 are based on a relatively large number of pixels. Accordingly, if a large variation in color values occurs in one or more of the image regions 602, this color variation information will be lost when the color value is selected or calculated for each of image regions 602. This can result in inaccurate color values being applied to the 3-D point cloud data. In contrast, if the image regions 604 are selected at block 308, the color values determined at block 310 are based on a relatively few number of pixels. Accordingly, a variation in color values in the radiometric image can be more accurately applied to the 3-D point cloud data. However, this can result in a larger number of color values that need to be stored and/or applied to the 3-D point cloud data, increasing computational costs. Therefore, in some embodiments of the invention, the region shape and/or size can be selected to improve computational efficiency and/or improve colorization accuracy according to one or more criteria. For example, in a combat scenario, where speed is essential and computational resources may be limited, reduced color accuracy may be acceptable in order to more quickly render the colorized 3-D point cloud in real-time. In contrast, in an intelligence gathering scenario, color accuracy may be critical for identification purposes. Consequently, additional computing resources may be available to allow the colorized 3-D point cloud to be rendered in a practical amount of time or additional amounts of time for rendering may be acceptable.

In some embodiments of the invention, method 300 can include post-processing techniques to improve colorization of the 3-D point cloud. That is, post-processing techniques can be used after region-based color values are applied at block 314 to adjust the color values at block 318 before the method 300 resumes previous processing at block 316. For example, if a plurality of 3-D data points are associated with each of the image regions, smoothing or interpolation techniques can be used to adjust the color values of the 3-D point cloud data to provide a more gradual transition in 3-D data point colorization from region to region. Such a configuration is useful when the resolution of the 3-D point cloud data is greater than the resolution of the radiometric image. In such circumstances, even if the image region size includes only one pixel, multiple 3-D data points will be identically colorized, resulting in abrupt color transitions being artificially inserted into the colorized 3-D point cloud data. Accordingly, such smoothing techniques can help reduce or eliminate the presence of artificial and incorrect abrupt transitions.

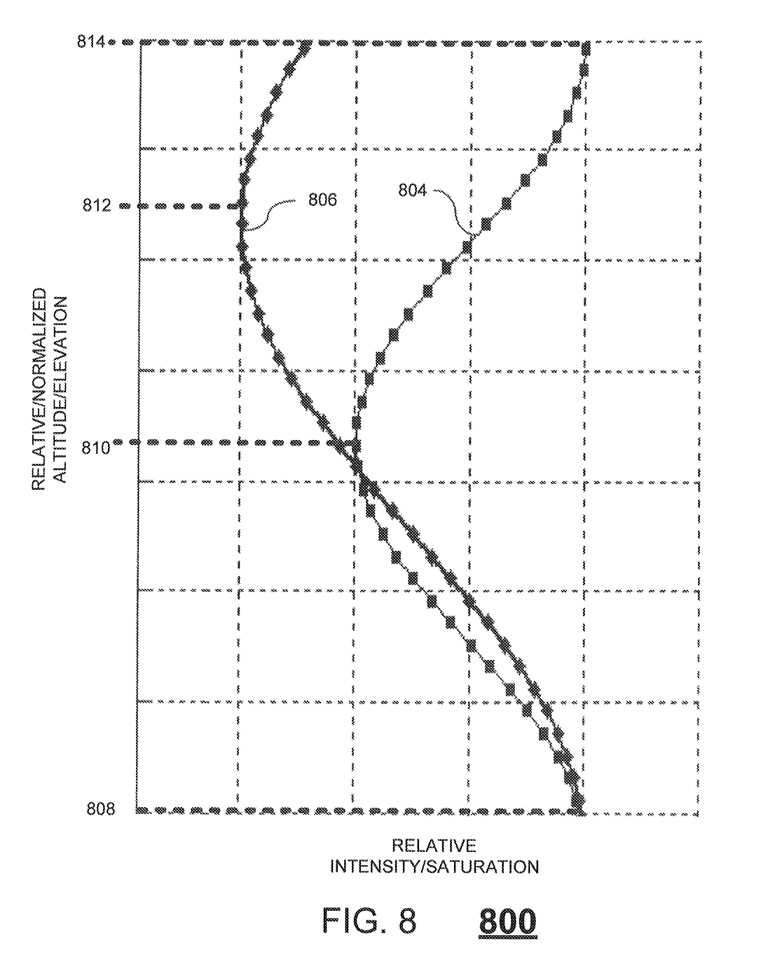

In another embodiment, the color values can be adjusted to account for different lighting or illumination of objects due to differences in altitude or elevation. This type of adjustment can be used to provide a more natural coloring of objects in the 3-D point cloud data. Such adjustments can be particularly useful when applying color values from a top-down aerial radiometric image, such as image 400 in FIG. 4, to 3-D point cloud data points on the sides of a vertically rising objects, such as the data points associated with buildings 500 in FIG. 5. Accordingly, rather than applying the same color value to all of the data points representing a 3-D object, the color values applied at block 314 can be adjusted, based on an elevation value of the 3-D data points associated with the object. For example, in one embodiment of the invention, the color values can be adjusted to present a more natural illumination of a 3-D object. One method is to provide an adjustment of saturation and/or intensity of the color values for the 3-D data points, as shown in FIG. 8.

FIG. 8 is an x-y plot 800 illustrating exemplary curves for adjusting color values with respect to altitude or elevation in accordance with an embodiment of the invention. In particular FIG. 8 provides curves for normalized curves for intensity 804 and saturation 806. It can be observed that the FIG. 8 is based on an HSI color space which varies in accordance with altitude or height above ground level. As an aid in understanding FIG. 8, various points of reference are provided. For example, FIG. 8 shows a lower height level 808, a first intermediate height level 810, a second intermediate height level 812, and a upper height level 814. In the various embodiments of the invention, these height levels can be normalized with respect to an uppermost height in an image region.

In some embodiments of the invention, hue values could also be adjusted as a function of elevation. However, in many cases hue values are typically held substantially constant as a function of elevation for purposes of applying color to 3-D point cloud data. Principally, this is because hue values represent the true of basic color being applied. Therefore, if hue values are adjusted, this can result in a change in the color being applied. That is, if a hue value is significantly as a function of elevation, this variation in hue values will manifest as a variation in basic colors or shades of a color. For example, if you have a red car and adjust the hue as you move across the car (assuming elevation changes), the car will be colored with different and distinct shades of red.

The normalized curves representing saturation and intensity, curves 804 and 806, respectively, have a local peak value at the lower height level 808. However, the normalized curves 804 and 806 for intensity and saturation are non-monotonic, meaning that they do not steadily increase or decrease in value with increasing elevation (altitude). According to an embodiment of the invention, each of these curves can first decrease in value within a predetermined range of altitudes above the lower height level 808, and then increase in value. For example, it can be observed in FIG. 8 that there is an inflection point in the normalized intensity curve 804 at the first intermediate height level 810. Similarly, there is an inflection point at the second intermediate height level 812 in the normalized saturation curve 806. The transitions and inflections in the non-linear portions of the normalized intensity curve 804, and the normalized saturation curve 806, can be achieved by defining each of these curves as a periodic function, such as a sinusoid. Still, the invention is not limited in this regard. Notably, the normalized intensity curve 804 returns to its peak value at the upper height level 814.

Notably, the peak in the normalized curves 804, 806 for intensity and saturation, respectively causes a spotlighting effect when viewing the 3D point cloud data. Stated differently, the data points that are located at the lower height level 808 a peak saturation and intensity. The visual effect is much like shining a light on the tops of object features at a ground level. The second peak in the intensity curve 804 at upper height level 814 has a similar visual effect when viewing the 3D point cloud data. However, in this case, rather than a spotlight effect, the peak in intensity values at the upper height level 814 creates a visual effect that is much like that of sunlight shining on the tops of objects. The saturation curve 806 shows a localized peak as it approaches upper height level 814. The combined effect helps greatly in the visualization and interpretation of the 3D point cloud data by providing a more natural illumination of the objects in the area.

Referring back to FIG. 3, the post-processing at block 318 can then be based on applying a colorspace, such as that in FIG. 8, to each of the points in an image region. In the various embodiments of the invention, such curves can be applied in a variety of ways. For example, in one embodiment of the invention the upper height level 814 can be selected based on a largest Z-value in the image region, the lower height level 808 can be selected based on a lowest Z-value in the image region, and the levels 810, 812 can be proportionally fixed with respect to the difference between the upper and lower height levels. However the embodiment of the invention are not limited in this regard. For example, the levels 810, 812 can be predefined for particular differences between the upper level. In another example, the lower height level can be based on a lowermost point in the 3-D point cloud, not just the data points in the image region. Regardless of how the colorspace is determined, the color values for the 3-D data points can then be modified according to their Z-values.

Although the adjustments described above can be applied to all of the data points in the 3-D point cloud, the various embodiments of the invention are not limited in this regard. In other embodiments, the adjustments may be applied to only a portion of the data points. For example, as described above, to provide proper colorization of the sides of a vertical object, vertical features in the 3-D point cloud data can be identified and the adjustment of saturation and/intensity can be applied solely to these vertical features. However, the invention is not limited in this regard and any type of feature can be selected for additional adjustments during post-processing.

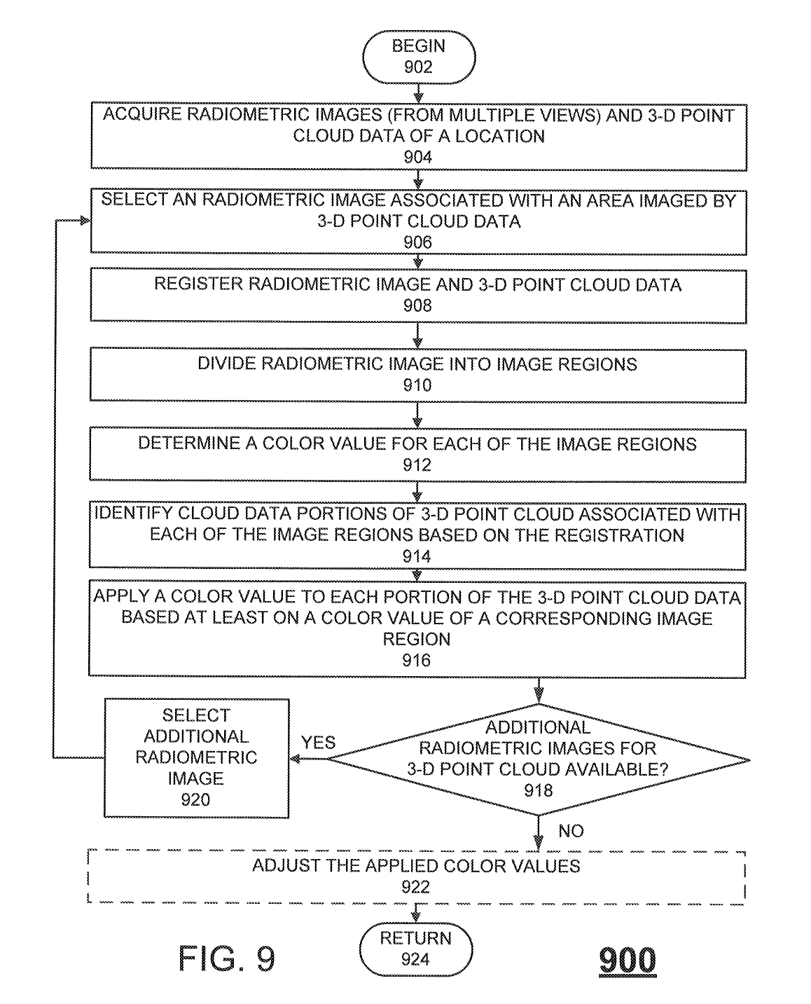

In method 300, the 3D-point cloud data is colorized using a single radiometric image or multiple radiometric images from a same frame of reference (e.g., a same sensor pose or location). Accordingly, color values will not be available for some features in the 3-D point cloud data as the associated features in the radiometric image may not be available or may be obscured. Therefore, in some embodiments of the invention, a 3-D point cloud may be colorized using multiple radiometric images from different frames of reference (i.e., different sensor poses or locations). For example, FIG. 9 shows an exemplary method 900 for point cloud colorization using multiple radiometric images in accordance with another embodiment of the invention.

Method 900 begins at block 902 and continues on to block 904. At block 904, the 3-D point cloud data and the radiometric images, using multiple sensor poses or locations, of a location being imaged are acquired, as described above with respect to FIG. 1. After the radiometric images and the 3-D point cloud data is acquired at block 904, one of the radiometric images is selected at block 908. Afterwards, color values are applied to the 3-D point cloud using blocks 908-916, in a similar fashion as that described above with respect to blocks 306-312 in FIG. 3.

Referring back to FIG. 9, once the color values from a radiometric image are applied to the 3-D point cloud in blocks 908-916, method 900 continues on to block 918. At block 918, method 900 determines whether any other radiometric images are available for the 3-D point cloud data set. If an additional radiometric image is available at block 918, the additional radiometric image is selected at block 920 and blocks 908-916 are repeated. Once no additional radiometric images are available at block 918, method 900 can optionally adjust the color values at block 922 (as previously described with respect to block 316 in FIG. 3) and resume previous processing at block 924.

Application of the color values at 916 for each radiometric image can be applied in several ways. In one embodiment of the invention, the color value applied to a 3-D point cloud data point can be an average color value from all the radiometric images associated with the 3-D data points. In another embodiment of the invention, a preferred color value can be selected. For example, based on the meta-data for the radiometric images and the 3-D point cloud data, it is possible to determine which ones of the radiometric images are associated with a particular orientation with respect to the 3-D point cloud data. Accordingly, only color values from those radiometric images associated with a particular orientation would be used for colorization of 3-D point cloud data points visible from this orientation. However, the various embodiments of the invention are not limited in this regard. Rather any other methods of selecting or calculating color values from multiple radiometric images can be used with the various embodiments of the invention.

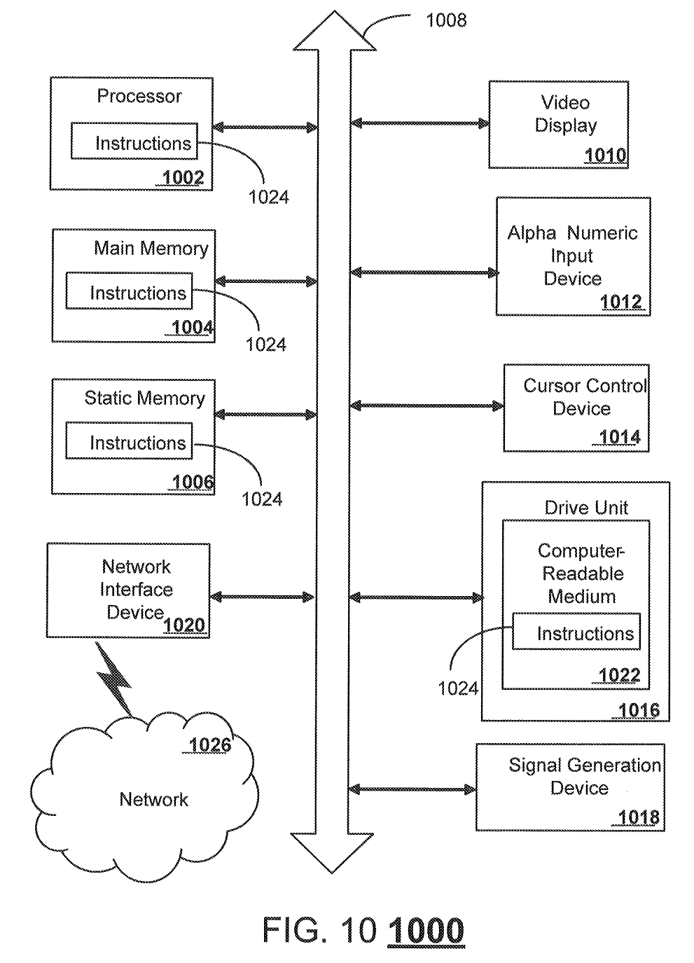

FIG. 10 is a schematic diagram of a computer system 1000 for executing a set of instructions that, when executed, can cause the computer system to perform one or more of the methodologies and procedures described above. In some embodiments, the computer system 1000 operates as a standalone device. In other embodiments, the computer system 1000 can be connected (e.g., using a network) to other computing devices. In a networked deployment, the computer system 1000 can operate in the capacity of a server or a client developer machine in server-client developer network environment, or as a peer machine in a peer-to-peer (or distributed) network environment.

The machine can comprise various types of computing systems and devices, including a server computer, a client user computer, a personal computer (PC), a tablet PC, a laptop computer, a desktop computer, a control system, a network router, switch or bridge, or any other device capable of executing a set of instructions (sequential or otherwise) that specifies actions to be taken by that device. It is to be understood that a device of the present disclosure also includes any electronic device that provides voice, video or data communication. Further, while a single computer is illustrated, the phrase “computer system” shall be understood to include any collection of computing devices that individually or jointly execute a set (or multiple sets) of instructions to perform any one or more of the methodologies discussed herein.

The computer system 1000 can include a processor 1002 (such as a central processing unit (CPU), a graphics processing unit (GPU, or both), a main memory 1004 and a static memory 1006, which communicate with each other via a bus 1008. The computer system 1000 can further include a display unit 1010, such as a video display (e.g., a liquid crystal display or LCD), a flat panel, a solid state display, or a cathode ray tube (CRT)). The computer system 1000 can include an input device 1012 (e.g., a keyboard), a cursor control device 1014 (e.g., a mouse), a disk drive unit 1016, a signal generation device 1018 (e.g., a speaker or remote control) and a network interface device 1020.

The disk drive unit 1016 can include a computer-readable storage medium 1022 on which is stored one or more sets of instructions 1024 (e.g., software code) configured to implement one or more of the methodologies, procedures, or functions described herein. The instructions 1024 can also reside, completely or at least partially, within the main memory 1004, the static memory 1006, and/or within the processor 1002 during execution thereof by the computer system 1000. The main memory 1004 and the processor 1002 also can constitute machine-readable media.

Dedicated hardware implementations including, but not limited to, application-specific integrated circuits, programmable logic arrays, and other hardware devices can likewise be constructed to implement the methods described herein. Applications that can include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the exemplary system is applicable to software, firmware, and hardware implementations.

In accordance with various embodiments of the present disclosure, the methods described herein can be stored as software programs in a computer-readable storage medium and can be configured for running on a computer processor. Furthermore, software implementations can include, but are not limited to, distributed processing, component/object distributed processing, parallel processing, virtual machine processing, which can also be constructed to implement the methods described herein.

The present disclosure contemplates a computer-readable storage medium containing instructions 1024 or that receives and executes instructions 1024 from a propagated signal so that a device connected to a network environment 1026 can send or receive voice and/or video data, and that can communicate over the network 1026 using the instructions 1024. The instructions 1024 can further be transmitted or received over a network 1026 via the network interface device 1020.

While the computer-readable storage medium 1022 is shown in an exemplary embodiment to be a single storage medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but not be limited to, solid-state memories such as a memory card or other package that houses one or more read-only (non-volatile) memories, random access memories, or other re-writable (volatile) memories; magneto-optical or optical medium such as a disk or tape; as well as carrier wave signals such as a signal embodying computer instructions in a transmission medium; and/or a digital file attachment to e-mail or other self-contained information archive or set of archives considered to be a distribution medium equivalent to a tangible storage medium. Accordingly, the disclosure is considered to include any one or more of a computer-readable medium or a distribution medium, as listed herein and to include recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

We claim:

1. A method for improving visualization and interpretation of spatial data of a location, comprising:
registering at least a first radiometric image and three-dimensional (3-D) point cloud data;
dividing the first radiometric image into a first plurality of image regions;
identifying one or more cloud data portions of said 3-D point cloud data associated with each of said first plurality of image regions based on said registering; and
applying portion color values to said cloud data portions, said portion color values comprising region color values for corresponding ones of said first plurality of regions.

2. The method of claim 1, wherein each of said cloud data portions further comprises one or more cloud data points specifying an elevation coordinate, the method further comprising:
separately adjusting the portion color values for said cloud data points based on said elevation coordinate.

3. The method of claim 2, wherein said adjusting comprises modifying at least one of a saturation and an intensity of said cloud data points.

4. The method of claim 1, wherein each of said cloud data portions further comprises one or more cloud data points, the method further comprising smoothing the portion color values for at least a portion of said cloud data points.

5. The method of claim 1, wherein said applying further comprises:
identifying a center pixel for each of said plurality of regions; and
selecting radiometric color values at said center pixel as said region color values.

6. The method of claim 1, wherein said applying further comprises:
calculating an average radiometric color values for each of said first plurality of regions; and
selecting said average radiometric color values as said region color values.

7. The method of claim 1, further comprising:
registering at least a second radiometric image and said 3-D point cloud data;
dividing the second radiometric image into a second plurality of image regions;
identifying said cloud data portions of said 3-D point cloud data associated with each of said second plurality of image regions based on said registering; and
modifying said portion color value for said cloud data portions based on at least region color values for corresponding ones of said second plurality of regions.

8. A system for improving visualization and interpretation of spatial data of a location, comprising:
a storage element for storing at least a first radiometric image and three-dimensional (3-D) point cloud data associated with said first radiometric image; and
a processing element communicatively coupled to said storage element, the processing element configured for:
registering at least a first radiometric image and three-dimensional (3-D) point cloud data;
dividing the first radiometric image into a first plurality of image regions;
identifying one or more cloud data portions of said 3-D point cloud data associated with each of said first plurality of image regions based on said registering; and
applying portion color values to said cloud data portions, said portion color values comprising region color values for corresponding ones of said first plurality of regions.

9. The system of claim 8, wherein each of said cloud data portions further comprises one or more cloud data points specifying an elevation coordinate, and wherein the processing element is further configured for:
separately adjusting the portion color values for said cloud data points based on said elevation coordinate.

10. The system of claim 9, wherein said processing element is further configured during said adjusting for modifying at least one of a saturation and an intensity of said cloud data points.

11. The system of claim 8, wherein each of said cloud data portions further comprises one or more cloud data points, and wherein the processing element is further configured for smoothing the portion color values for at least a portion of said cloud data points.

12. The system of claim 8, wherein said processing element is further configured during said applying for:
identifying center pixels for each of said plurality of regions; and
selecting radiometric color values at said center pixel as said region color values.

13. The system of claim 8, wherein said processing element is further configured during said applying for:
calculating average radiometric color values for each of said first plurality of regions.
selecting said average radiometric color values as said region color value.

14. The system of claim 8, wherein said storage element is further configured for storing at least a second radiometric image associated with said 3-D point cloud data, and said processing element is further configured for:
registering said second radiometric image and said 3-D point cloud data;
dividing the second radiometric image into a second plurality of image regions;
identifying said cloud data portions of said 3-D point cloud data associated with each of said second plurality of image regions based on said registering; and
modifying said portion color value for said cloud data portions based on at least region color values for corresponding ones of said second plurality of regions.

15. A computer-readable medium, having stored thereon a computer program for improving visualization and interpretation of spatial data of a location, the computer program comprising a plurality of code sections, the plurality of code sections executable by a computer for causing the computer to perform the steps of:
registering at least a first radiometric image and three-dimensional (3-D) point cloud data;
dividing the first radiometric image into a first plurality of image regions;
identifying one or more cloud data portions of said 3-D point cloud data associated with each of said first plurality of image regions based on said registering; and
applying portion color values to said cloud data portions, said portion color values comprising region color values for corresponding ones of said first plurality of regions.

16. The computer-readable medium of claim 15, wherein each of said cloud data portions further comprises one or more cloud data points, and further comprising code sections for:
separately adjusting the portion color values for at least a portion of said cloud data points.

17. The computer-readable medium of claim 16, further comprising code sections for modifying at least one of a saturation and an intensity of said cloud data points during said adjusting based on an elevation coordinate for said cloud data points.

18. The computer-readable medium of claim 15, said plurality of code sections for said applying further comprising code sections for:
identifying center pixels for each of said plurality of regions; and
selecting radiometric color values at said center pixel as said region color values.

19. The computer-readable medium of claim 15, said plurality of code sections for said applying further comprising code sections for:
calculating an average radiometric color values for each of said first plurality of regions; and
selecting said average radiometric color values as said region color values.

20. The computer-readable medium of claim 15, further comprising code sections for:
registering at least a second radiometric image and said 3-D point cloud data;
dividing the second radiometric image into a second plurality of image regions;
identifying said cloud data portions of said 3-D point cloud data associated with each of said second plurality of image regions based on said registering; and
modifying said portion color value for said cloud data portions based on at least region color values for corresponding ones of said second plurality of regions.
